(19) United States
(12) Patent Application Publication
(10) Pub. No.: US 2025/0110220 A1
(43) Pub. Date: Apr. 3, 2025

(54) DISTANCE MEASUREMENT DEVICE AND EQUIPMENT

(71) Applicant: CANON KABUSHIKI KAISHA, Tokyo (JP)

(72) Inventor: KAZUMA CHIDA, Tokyo (JP)

(21) Appl. No.: 18/887,199

(22) Filed: Sep. 17, 2024

(30) Foreign Application Priority Data
Sep. 28, 2023 (JP) 2023-168872

(51) Int. Cl. G01S 7/4863; G01S 7/4865; G01S 17/18; G01S 17/894

(52) U.S. Cl. CPC G01S 7/4863; G01S 7/4866; G01S 17/18; G01S 17/894

(57) ABSTRACT

A distance measurement device including pixels and a calculator configured to generate distance information based on signals obtained by the pixels is provided. A sequence for generating the distance information includes distance measurement frames, and each of the distance measurement frames includes subframes which are different from each other in a time between light emission by a light source and a period in which a detection operation of detecting light reflected by a target object is performed. The device further comprises a stop controller configured to generate a stop signal if signals obtained by the detection operations respectively performed in the subframes satisfy a predetermined condition. Among the distance measurement frames, in a distance measurement frame after the stop signal is supplied from the stop controller, each of the pixels does not perform the detection operation.

### BACKGROUND OF THE INVENTION

### Field of the Invention

The present disclosure relates to a distance measurement device and equipment.

### Description of the Related Art

There is known a Time of Flight (ToF) distance measurement device that measures a distance by detecting light emitted from a light source and reflected by a target object. US-2017-0052065 discloses distance measurement using a time gate method. In the time gate method, during a period for performing a distance measurement operation of measuring the distance to a target object, the distance measurement operation is performed over a plurality of frames which are different from each other in the time from light emission to a detection operation of detecting the light reflected by the target object.

In a case of measuring the distance to an object with low reflectance, the distance measurement operation may be repeated a plurality of times to improve the reflected light detection accuracy. However, repeating the distance measurement operation increases power consumption.

Some embodiments of the present disclosure provide a technique advantageous in suppressing power consumption.

### SUMMARY OF THE INVENTION

According to some embodiments, a distance measurement device comprising: a plurality of pixels each including a photoelectric conversion element; and a calculation circuit configured to generate distance information based on signals obtained by the plurality of pixels, wherein a sequence for generating the distance information includes a plurality of distance measurement frames, each of the plurality of distance measurement frames includes a plurality of subframes which are different from each other in a time between light emission by a light source and a period in which a detection operation of detecting light reflected by a target object is performed by applying a reverse bias to the photoelectric conversion element, the device further comprises a stop control circuit configured to generate a stop signal if a plurality of signals obtained by the detection operations respectively performed in the plurality of subframes satisfy a predetermined condition in the plurality of distance measurement frames, and among the plurality of distance measurement frames, in a distance measurement frame after the stop signal is supplied from the stop control circuit, each of the plurality of pixels does not perform the detection operation, is provided.

Further features of the present invention will become apparent from the following description of exemplary embodiments (with reference to the attached drawings).

### BRIEF DESCRIPTION OF THE DRAWINGS

FIG. 1 is a view showing an arrangement example of a distance measurement device according to an embodiment;

FIG. 2 is a view showing an arrangement example of the light receiver of the distance measurement device in FIG. 1;

FIG. 3 is a view showing an arrangement example of the pixel of the distance measurement device in FIG. 1;

FIG. 4 is a view showing an operation example of the distance measurement device in FIG. 1;

FIGS. 5A and 5B are views each showing an operation example of the distance measurement device in FIG. 1;

FIG. 6 is a view showing an operation example of the distance measurement device in FIG. 1;

FIG. 7 is a view showing a modification of the distance measurement device in FIG. 1;

FIG. 8 is a view showing an arrangement example of a pixel of the distance measurement device in FIG. 7; and

FIG. 9 is a view showing an arrangement example of equipment incorporating the distance measurement device according to the embodiment.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

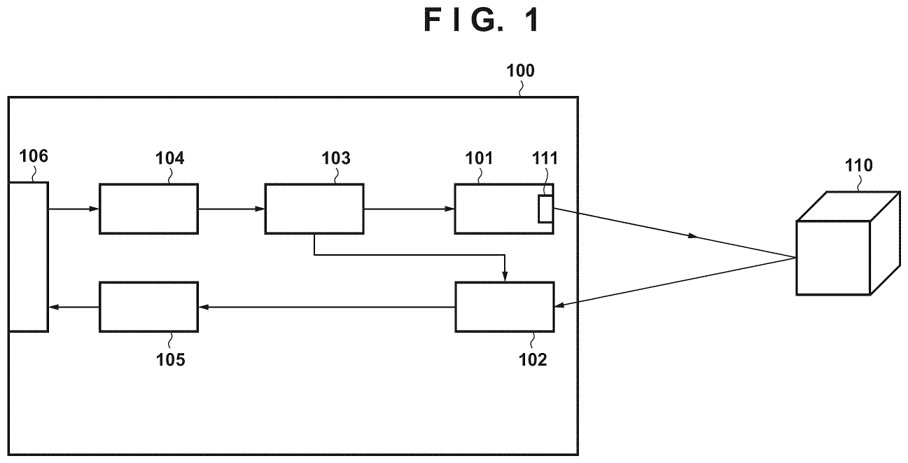

A distance measurement device according to an embodiment of the present disclosure will be explained with reference to FIGS. 1 to 8. FIG. 1 is a block diagram schematically showing an arrangement example of a distance measurement device 100 according to the embodiment. As shown in FIG. 1, the distance measurement device 100 includes a light emitter 101, a light receiver 102, a timing controller 103, a register 104, a calculation circuit 105, and a communication interface (IF) 106.

The timing controller 103 controls the operation timing of each component arranged in the distance measurement device 100. More specifically, the timing controller 103 outputs to the light emitter 101 a control signal for controlling the timing when the light emitter 101 emits light. Further, the timing controller 103 outputs to the light receiver 102 a control signal for controlling the timing when the light receiver 102 performs a detection operation of detecting light reflected by a target object.

The light emitter 101 includes a light source 111 that emits light based on the control signal from the timing controller 103. As the light source 111, for example, a semiconductor laser diode is used. In this case, the light source 111 emits a laser beam having a predetermined pulse width in accordance with the control signal supplied from the timing controller 103. An optical member (not shown) such as a diffuser is arranged in the light emitter 101, and light emitted from the light source 111 is diffused to irradiate a predetermined two-dimensional range.

The light receiver 102 includes a so-called image sensor. The light receiver 102 may be, for example, a CMOS sensor or a SPAD sensor using an avalanche photodiode (to be also referred to as an APD hereinafter). The arrangement of the light receiver 102 will be described later.

The calculation circuit 105 is arranged to generate information of the distance to a target object 110 based on signals obtained by a plurality of pixels arranged in the light receiver 102. The calculation circuit 105 may generate a three-dimensional distance image or the like from the obtained distance information. For the calculation circuit 105, a semiconductor device such as a CPU or an ASIC may be used.

Setting values and the like for operating the distance measurement device 100 are stored in the register 104. The communication IF 106 is arranged to externally output data such as distance measurement information obtained by the distance measurement device 100. Data for operating the distance measurement device 100 may be supplied to the register 104 via the communication IF 106.

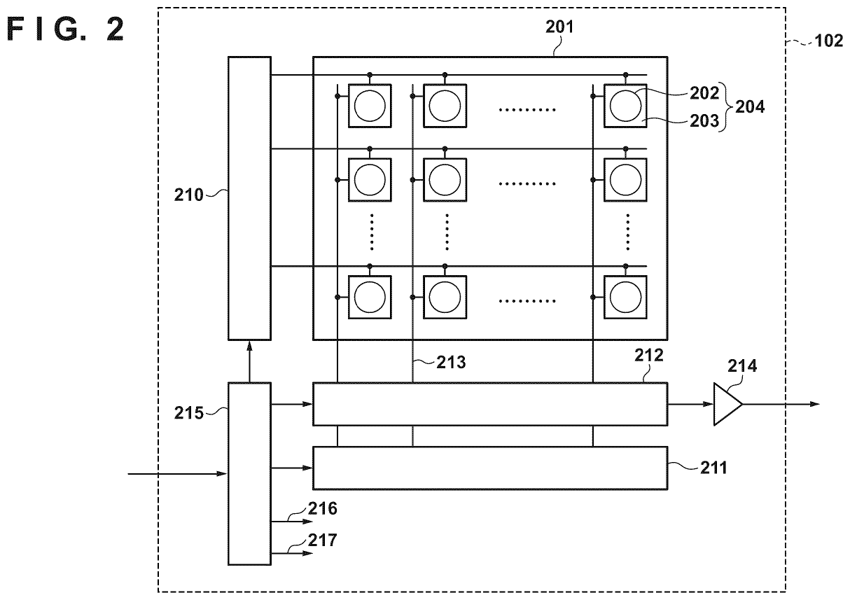

FIG. 2 is a block diagram showing an arrangement example of the light receiver 102 according to the embodiment. The light receiver 102 can include a pixel portion 201, a control pulse generation circuit 215, a vertical scanning circuit 210, a horizontal scanning circuit 211, a readout circuit 212, signal lines 213, 216, and 217, and an output circuit 214.

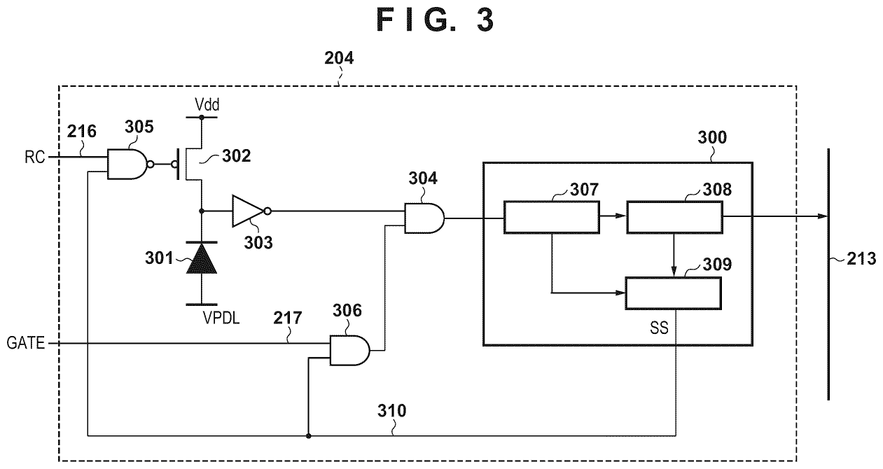

In the pixel portion 201, a plurality of pixels 204 are arranged in a two-dimensional array (rows and columns). Each pixel 204 includes a photoelectric conversion circuit 202 and a pixel circuit 203. In the embodiment, the photoelectric conversion circuit 202 includes an APD as a photoelectric conversion element, which will be described later with reference to FIG. 3. In the embodiment, the pixel 204 arranged in the pixel portion 201 includes the photoelectric conversion circuit 202 and the pixel circuit 203. However, the arrangement is not limited to this and it suffices to at least arrange APDs in a two-dimensional array in the pixel portion 201. Light entering the pixel portion 201 is converted into an electrical signal by the pixel 204 arranged in the pixel portion 201. The pixel circuit 203 outputs to the signal line 213 the electrical signal photoelectrically converted by the photoelectric conversion circuit 202.

The control pulse generation circuit 215 controls the vertical scanning circuit 210, the horizontal scanning circuit 211, and the readout circuit 212 in accordance with control signals supplied from the timing controller 103. Further, the control pulse generation circuit 215 supplies control pulses to respective pixels 204 via the signal lines 216 and 217.

The vertical scanning circuit 210 supplies a control pulse to each pixel 204 in accordance with a control pulse supplied from the control pulse generation circuit 215. A logic circuit such as a shift register or an address decoder may be used for the vertical scanning circuit 210.

A signal output from the photoelectric conversion circuit 202 of each pixel 204 is processed by the pixel circuit 203. A counter circuit and the like may be provided in the pixel circuit 203. A stop control circuit (to be described later in detail) can also be arranged in the pixel circuit 203.

The horizontal scanning circuit 211 supplies, to the pixel circuit 203, a control pulse for sequentially selecting the pixels 204 arranged in the pixel portion 201 for respective columns in order to read out signals from the memories of the pixels 204 that hold digital signals. For a selected row, a signal is output to the signal line 213 from the pixel circuit 203 of the pixel 204 selected by the vertical scanning circuit 210. The signal output to the signal line 213 is output to the calculation circuit 105 via the readout circuit 212 including, for example, a multiplexer or the like and the output circuit 214.

In the arrangement shown in FIG. 2, the pixels 204 are arranged in a two-dimensional array in the pixel portion 201. However, the arrangement is not limited to this, and the pixels 204 may be arranged one-dimensionally in the pixel portion 201. Alternatively, only a single pixel 204 may be arranged in the pixel portion 201.

FIG. 3 is a block diagram showing an arrangement example of the pixel 204 according to the embodiment. As described above, the pixel 204 includes the photoelectric conversion circuit 202 and the pixel circuit 203. In the arrangement shown in FIG. 3, the photoelectric conversion circuit 202 includes an APD 301 as a photoelectric conversion element. The pixel circuit 203 includes a quench element 302, a waveform shaping circuit 303, gate elements 304 to 306, and a distance measurement circuit 300. The distance measurement circuit 300 includes a counter circuit 307, a processing circuit 308, and a stop control circuit 309.

The APD 301 is connected to the quench element 302 that controls an avalanche current. A photon detection signal output from the APD 301 via the waveform shaping circuit 303 is temporally controlled by a pulse signal GATE supplied from the control pulse generation circuit 215 to the gate element 304 via the signal line 217. An output from the gate element 304 is input to the distance measurement circuit 300.

The APD 301 generates a charge pair corresponding to incident light by photoelectric conversion. A potential based on a potential Vdd higher than a potential VPDL supplied to the anode of the APD 301 is supplied to the cathode. The potentials Vdd and VPDL are supplied between the anode and cathode of the APD 301 to apply such a reverse bias that causes avalanche multiplication on photons entering the APD 301. When photoelectric conversion is performed in a state in which the reverse bias is supplied, charges generated by incident light cause avalanche multiplication in the APD 301, generating an avalanche current.

When the potential difference (voltage) between the anode and the cathode is larger than a breakdown voltage in a case where the reverse bias voltage is supplied, the APD 301 performs a Geiger mode operation. The APD 301 that quickly detects a faint signal of a single photon level using the Geiger mode operation is sometimes called a Single Photon Avalanche Diode (SPAD). Although the SPAD is used to quickly detect a faint signal in the embodiment, the operation mode of the APD 301 may be a linear mode operation in which avalanche multiplication is caused at a voltage equal to or lower than the breakdown voltage.

The quench element 302 has a function of converting a change of the avalanche current generated in the APD 301 into a voltage signal. If the photocurrent is multiplied by avalanche multiplication in the APD 301, a current obtained by multiplied charges flows to a connection node between the APD 301 and the quench element 302. A voltage drop caused by the current decreases the potential of the cathode of the APD 301, and the APD 301 does not form an electron avalanche. As a result, the avalanche multiplication of the APD 301 stops. Then, the potential Vdd of the power supply is supplied to the cathode of the APD 301 via the quench element 302, and the potential supplied to the cathode of the APD 301 returns to the potential Vdd. That is, the operation region of the APD 301 returns again to the Geiger mode operation. In this manner, the quench element 302 functions as a load circuit (quench element) at the time of multiplying charges by avalanche multiplication, and operates to suppress avalanche multiplication (quench operation). After suppressing avalanche multiplication, the quench element 302 operates to return the operation region of the APD 301 again to the Geiger mode (recharge operation). The application of the reverse bias to the APD 301 by the recharge operation is temporally controlled by a pulse signal RC supplied from the control pulse generation circuit 215 to the gate element 305 via the signal line 216.

For the waveform shaping circuit 303, for example, an inverter circuit is used. The waveform shaping circuit 303 shapes a potential change of the cathode of the APD 301 obtained at the time of photon detection, and outputs a pulse signal.

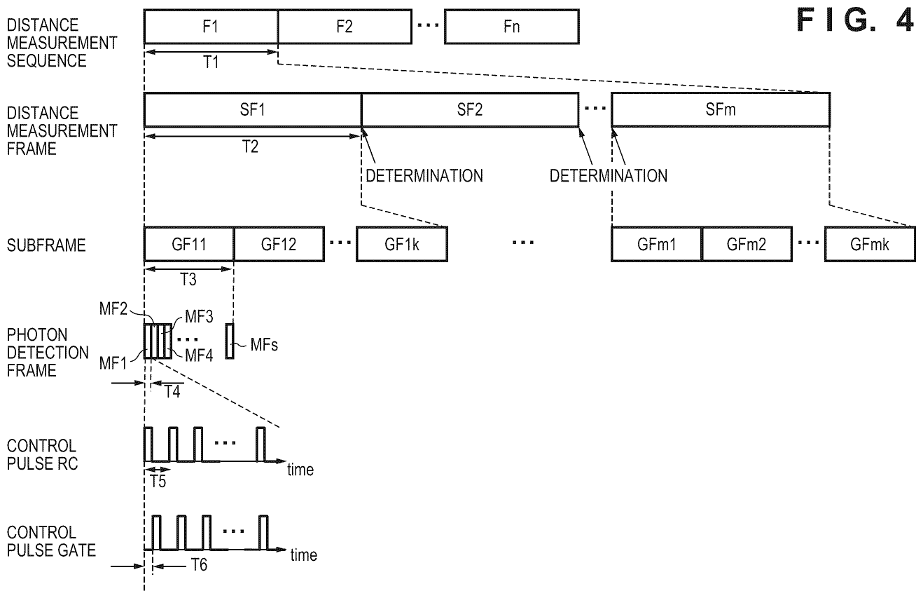

For the gate element 304, for example, an AND circuit is used. By controlling the High/Low level of the control pulse GATE, the gate element 304 adjusts a period in which the detection operation of detecting light by the pixel 204 is performed. The detection period is a period in which photon detection is possible in the APD 301, and a period in which a pulse signal obtained by converting a potential change of the APD 301 by the waveform shaping circuit 303 is output to the counter circuit 307. A period in which no detection operation is performed in the pixel 204 is sometimes called a non-detection period. The non-detection period is a period in which no pulse signal is output from the waveform shaping circuit 303 to the counter circuit 307. In the operation example shown in FIG. 4 to be described later, a time during which the control pulse GATE is at the High level is the period in which the detection operation is performed, and a time during which the control pulse GATE is at the Low level is the non-detection period.

The counter circuit 307 arranged in the distance measurement circuit 300 is configured to be capable of outputting signals to the processing circuit 308 and the stop control circuit 309. The counter circuit 307 counts the number of times a photon is detected in the APD 301 in the detection operation. To generate information of distance to the target object 110, the processing circuit 308 arranged in the distance measurement circuit 300 generates a plurality of signals each indicating the count value of the counter circuit 307 at each timing when the detection operation is performed. The signal generated by the processing circuit 308 is output to the signal line 213. Based on the signal value (electrical signal) of the signal output from the processing circuit 308, the calculation circuit 105 can generate information of distance to the target object 110, thereby performing distance measurement.

FIG. 4 is a timing chart showing a time gate ToF operation timing according to the embodiment. In the embodiment, a sequence F for generating one piece of distance information includes a plurality of distance measurement frames SF. In the configuration shown in FIG. 4, a period T1 of one sequence F is formed from m distance measurement frames SF each having a period T2.

Each of the plurality of distance measurement frames SF includes a plurality of subframes GF which are different from each other in the time between light emission by the light source 111 and the period in which the detection operation of detecting the light reflected by the target object 110 is performed by applying a reverse bias to the APD 301 serving as the photoelectric conversion element. In the configuration shown in FIG. 4, the period T2 of one distance measurement frame SF is formed from k subframes GF each having a period T3. That is, there are k types of subframes GF which are different from each other in the time between light emission by the light source 111 and the period in which the detection operation of detecting light by the APD 301 is performed.

Each subframe GF is formed from s photon detection frames MF each having a period T4. The number k of the subframes GF included in one distance measurement frame SF and the number s of the photon detection frames MF included in one subframe GF can have, for example, a relationship expressed by k≤s, but the relationship is not limited to this. The light source 111 emits light at the start of each subframe GF. In accordance with the light emission by the light source 111, the detection operation is performed. In a subframe GF11, the rising position of the control pulse RC and the rising position of the control pulse GATE have a phase relationship T6. Then, while maintaining the same phase relationship, the detection operation is performed in a photon detection frame MF2. Subsequently, the detection operations are performed up to a photon detection frame MFs. In a subframe GF12, the phase relationship between the rising position of the control pulse RC and the rising position of the control pulse GATE is shifted from the phase relationship T6 by a certain amount, and the detection operation is performed in a photon detection frame MF1. In this manner, the detection operations are sequentially performed up to a subframe GF1k at timings with different times from light emission.

Among the photon detection frames MF, in the photon detection frame where the detection operation is performed, the control pulse RC and the control pulse GATE are supplied as shown in FIG. 4. The control pulse RC causes the recharge operation in which a reverse bias is applied to the APD 301 serving as the photoelectric conversion element. Thus, a state in which light detection is possible is set. Then, the control pulse GATE is supplied. In this state, if a photon is detected by the APD 301, the potential change of the APD 301 is converted into a pulse signal by the waveform shaping circuit 303 and output to the counter circuit 307. By repeatedly supplying the control pulse RC and the control pulse GATE in one photon detection frame MF, the counter circuit 307 counts the number of times a photon is detected by the APD 301. Alternatively, one photon detection frame MF may be a frame for calculating the logical sum of outputs from the APD 301 to form a 1-bit image. In this case, in the period T4 of the photon detection frame MF, “1” is set if a photon is detected by the APD 301 at least once, and “O” is set if no photon is detected. The counter circuit 307 includes a memory for holding 1-bit information, and “1” is held for the photon detection frame MF where a photon is detected. At the timing of updating the photon detection frame MF, the counter of the counter circuit 307 is incremented, and the 1-bit memory is reset.

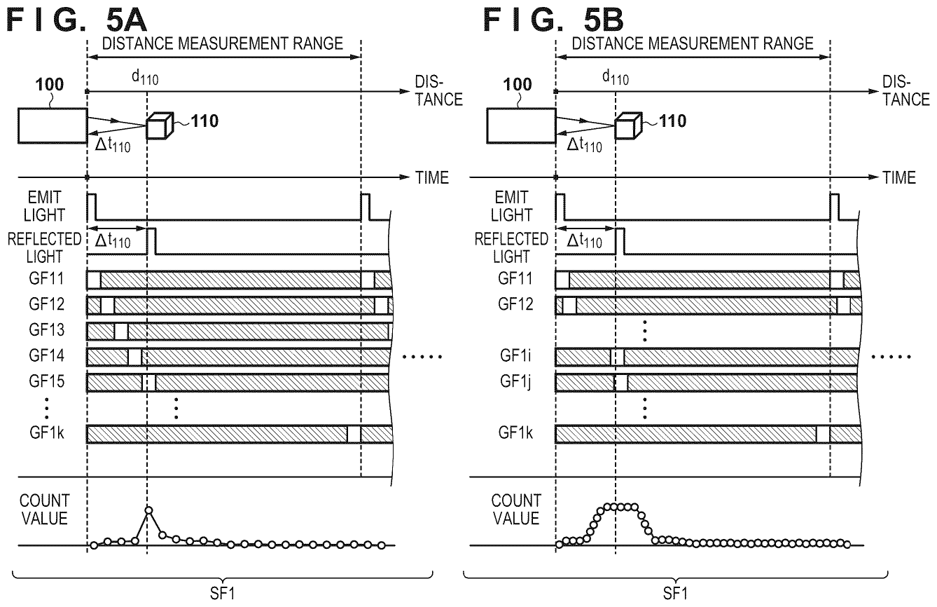

FIG. 5A is a view showing an operation example in one distance measurement frame SF. In each subframe GF, a white portion indicates the timing when the detection operation is performed, and a black portion indicates the non-detection period. From the subframes GF, it can be seen that the detection operations are performed at timings with different times from light emission by the light source 111. The example shown in FIG. 5A shows that the light reflected by the target object 110 is detected in a subframe GF 15. The processing circuit 308 transmits, to the calculation circuit 105, the signals (count value) obtained in the respective subframes GF. Thus, the calculation circuit 105 can generate distance information.

In the embodiment, as described above, the calculation circuit 105 can generate, by one sequence F, one three-dimensional distance image or the like from the obtained distance information. In a case of measuring the distance to an object with low reflectance or the like, if only the signal obtained by the operation in one distance measurement frame SF is used, the signal (count value) obtained by the detection operation may be small and the S/N ratio may not be obtained. Therefore, in the embodiment, the operation in the distance measurement frame SF is repeated a plurality of times in one sequence F. With this, it is possible to improve the accuracy of detecting the reflected light and, as a result, improve the distance measurement accuracy. However, if the distance measurement frame SF is repeated in one sequence F, power consumption can increase due to repeating the above-described recharge operations or the like.

To solve this problem, in the embodiment, the stop control circuit 309 is arranged in the distance measurement circuit 300 as shown in FIG. 3. In the plurality of distance measurement frames SF, if a plurality of signals obtained by the detection operations respectively performed in the plurality of subframes GF satisfy a predetermined condition, the stop control circuit 309 generates a stop signal SS. The “plurality of signals” obtained by the detection operations respectively performed in the plurality of subframes GF are the count values at the timings when the detection operations are performed, which are generated by the processing circuit 308 as described above. For example, a plurality of white circles indicated by the count values in FIG. 5A correspond to the “plurality of signals”.

Consider a case of measuring the distance to an object with low reflectance as described above. In this case, the stop control circuit 309 may generate the stop signal SS for each of the plurality of pixels 204 based on a plurality of signal values obtained by integrating, for the plurality of subframes GF, the signal values of a plurality of signals obtained in each of the plurality of distance measurement frames SF. The processing circuit 308 can integrate the signal values for the subframes GF. For example, if one or more signal values of the signal values of the plurality of signals are equal to or larger than a predetermined threshold value, the stop control circuit 309 may determine that the predetermined condition is satisfied and generate the stop signal SS. That is, it can be said that the stop control circuit 309 generates the stop signal SS when data for deciding the distance (data for generating distance information) is obtained.

The stop signal SS is a low-level signal supplied to the gate element 305 or 306 via a signal line 310 shown in FIG. 3. If the stop signal SS is supplied to the gate element 305, the above-described recharge operation is not performed regardless of the level of the control pulse RC. That is, among the plurality of distance measurement frames SF, in the distance measurement frame SF after the stop signal SS is supplied from the stop control circuit 309, the reverse bias is not applied to the APD 301 so each of the plurality of pixels 204 does not perform the detection operation. This enables suppressing power consumption in the distance measurement frame SF after sufficient data for generating the distance information are obtained.

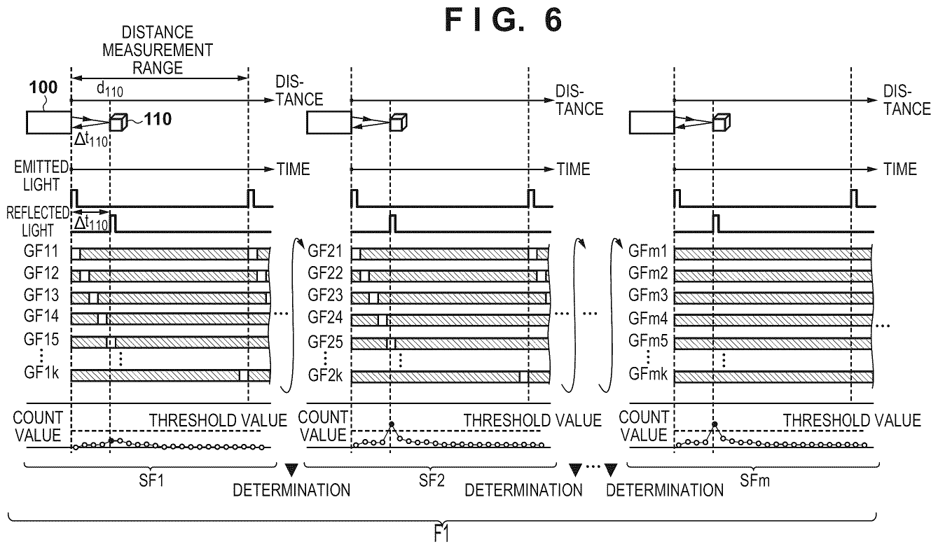

FIG. 6 shows an operation example focusing on one pixel 204. Since none of the signal values of signals obtained in a distance measurement frame SF1 reaches the predetermined threshold value, the stop control circuit 309 does not generate the stop signal SS. It can also be said that the stop control circuit 309 determines whether to generate the stop signal SS. Since the stop signal SS is not generated, the detection operation (the white portion in the subframe GF) is also performed in a distance measurement frame SF2 next to the distance measurement frame SF1. Due to the detection operation in the distance measurement frame SF2, the integrated value of the signal in a subframe GF15 and the signal in a subframe GF25 among the signal values obtained by integrating the signals obtained in the distance measurement frames SF1 and SF2 for each subframe GF reaches the predetermined threshold value. Therefore, the stop control circuit 309 generates the stop signal SS. Hence, the stop signal SS is supplied, so that the pixel 204 shown in FIG. 6 does not perform the detection operation as shown in a distance measurement frame SFm. Accordingly, the detection operation is stopped, and power consumption can be suppressed. As shown in FIG. 6, the stop control circuit 309 may determine whether to generate the stop signal SS every time each distance measurement frame SF ends. Alternatively, for example, the stop control circuit 309 may not perform the determination after generating the stop signal SS, and continue to supply the stop signal SS until one sequence F ends.

If the stop signal SS is generated due to the detection operation in the distance measurement frame SF2, the stop signal SS can be supplied to the pixel 204 during, for example, a distance measurement frame SF3. In this case, in the arrangement of the pixel 204 shown in FIG. 3, the detection operation is stopped from the subframe of the timing when the stop signal SS is supplied in the distance measurement frame SF3. Alternatively, the detection operation is not performed in a distance measurement frame SF4 and subsequent frames after the distance measurement frame SF3 where the stop signal SS is supplied from the stop control circuit 309.

In a case where the plurality of signals having one peak value are obtained as shown in FIGS. 5A and 6, the predetermined condition for the stop control circuit 309 to generate the stop signal SS may be a case where one or more signal values of the plurality of signal values are equal to or larger the predetermined threshold value as described above. The one or more signal values may include one peak value. If the signal value exceeds the predetermined threshold value, it can be determined that data for generating the distance information has been obtained. The threshold value may be set in consideration of the difference between the peak value and the floor noise of the plurality of signals obtained by the detection operations. The distance measurement device 100 may be configured to allow a user to set the threshold value as appropriate. With this, even in an environment where external light having high floor noise is strong, the stop signal SS is generated at a proper timing. Thus, the distance measurement accuracy can be improved.

The stop control circuit 309 may include a comparator circuit that simply compares the plurality of signal values with the predetermine threshold value. If one of the plurality of signal values exceeds the threshold value, the stop control circuit 309 generates the stop signal SS. Alternatively, the stop control circuit 309 may detect the signal value to be compared with the threshold value based on the first derivative value of a histogram (represented by a line graph of the plurality signals (the plurality of white circles) indicating the count values in FIG. 5A) obtained from the plurality of signal values. That is, the signal value to be compared with the threshold value can be acquired from the rising edge of the histogram or the falling edge of the histogram (after exceeding the predetermined value).

The predetermined condition for the stop control circuit 309 to generate the stop signal SS is not limited to the comparison of the peak value and the threshold value as described above. For example, the stop control circuit 309 may generate the stop signal SS if the degree of similarity between a predetermined waveform and the waveform of the histogram obtained from the plurality of signal values falls within a predetermined range. The predetermined waveform can be an assumed waveform generated in advance using simulation or the like. The predetermined waveform used for comparison of the degree of similarity may be an appropriate waveform selected by the user from a plurality of simulation waveforms in accordance with the specifications of the distance measurement device 100, the distance measurement environment, or the like, or may be an appropriate waveform automatically selected by the distance measurement device 100 (for example, stop control circuit 309).

Not one peak value as shown in FIG. 5A but a broad peak over some subframes as shown in FIG. 5B may be obtained. Even in this case, for example, the stop control circuit 309 may generate the stop signal SS if the plurality of signal values are simply compared with the predetermined threshold value and the set threshold value is exceeded. Alternatively, in a case where the histogram as shown in FIG. 5B is obtained, one or more signal values to be compared with the threshold value may be detected based on the first derivative values (rising edge and falling edge) of the histogram, and the detected one or more signal values may be compared with the threshold value. Alternatively, for example, the stop control circuit 309 may detect one or more signal values to be compared with the threshold value from the inflection point at the rising edge and that at the falling edge of the histogram based on the second derivative values of the histogram obtained from the plurality of signal values. As compared to the distance measurement using the peak value, using the first derivative values or second derivative values can generate the stop signal SS at the proper timing, thereby improving the distance measurement accuracy. In these cases, one or more signal values to be compared with the threshold value can also include the peak value of the plurality of signal values. Alternatively, as described above, the stop signal SS may be generated based on comparison of the waveform of the histogram obtained from the plurality of signals with the predetermined waveform.

As shown in FIG. 3, the stop control circuit 309 may be arranged in each of the plurality of pixels 204. In this case, the stop control circuit 309 may generate the stop signal for each pixel 204 of the plurality of pixels 204 based on a plurality of signals obtained by each pixel 204. Hence, power consumption can be suppressed for each pixel 204 in the distance measurement sequence F.

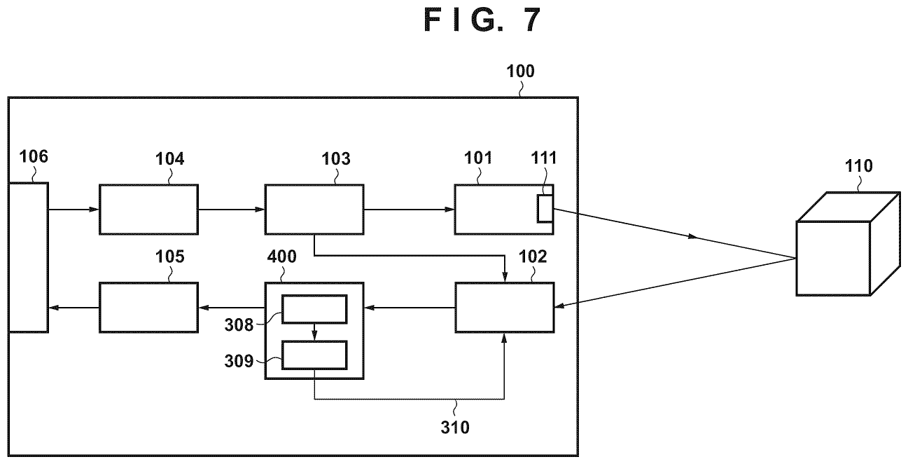

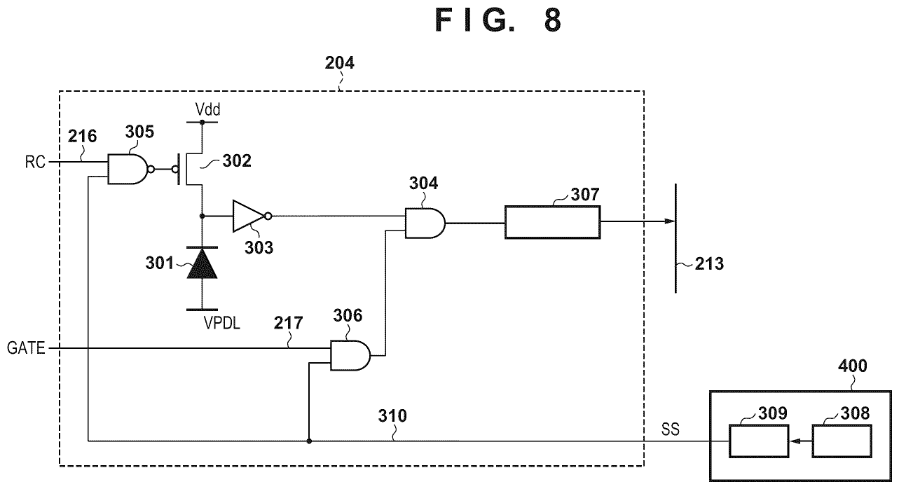

However, the stop control circuit 309 is not limited to be arranged in each pixel 204. FIG. 7 is a block diagram showing a modification of the distance measurement device 100 shown in FIG. 1. FIG. 8 is a view showing an arrangement example of the pixel 204 arranged in the distance measurement device 100 shown in FIG. 7. In the arrangement shown in FIGS. 7 and 8, a distance measurement circuit 400 including the processing circuit 308 and the stop control circuit 309 is arranged outside the light receiver 102 including the pixel portion 201 (see FIG. 2) where the plurality of pixels 204 are arranged. In addition, the counter circuit 307 of the distance measurement circuit 300 shown in FIG. 3 is arranged in the pixel 204 as shown in FIG. 8. The remaining arrangement may be similar to that described above, so that a description of the similar arrangement will be omitted, as appropriate.

In the arrangement shown in FIGS. 7 and 8, a signal counted by the counter circuit 307 is supplied to the processing circuit 308 of the distance measurement circuit 400 via the signal line 213, and processing similar to the processing described above is performed. The stop control circuit 309 generates the stop signal SS as in the above description based on the signal values of a plurality of signals generated by the processing circuit 308.

Also in the arrangement shown in FIGS. 7 and 8, the stop control circuit 309 may generate, for each pixel 204 of the plurality of pixels 204, the stop signal SS based on a plurality of signals obtained by each pixel 204. With this, power consumption is suppressed for each pixel 204, and low power consumption of the distance measurement device 100 is implemented.

However, if the stop signal SS is generated for each pixel 204, the circuit configuration may become complicated due to the arrangement of the signal lines 310 for individually supplying the stop signal SS to each pixel 204. Therefore, the stop control circuit 309 may generate the stop signal SS based on the plurality of signals obtained by each pixel 204 arranged in a predetermined region among the plurality of pixels 204. For example, if the plurality of signals obtained from each of a predetermined number of pixels 204 of the pixels 204 arranged in the predetermined region satisfy the predetermined condition for generating the stop signal SS, the stop control circuit 309 may supply the stop signal SS to all the pixels 204 arranged in the predetermined region. With the configuration in which the stop signal SS is supplied on the predetermined region basis, the circuit configuration between the stop control circuit 309 and the pixel portion 201 can be simplified as compared to the case of supplying the stop signal SS for each pixel 204.

For example, the pixel portion 201 is divided into an appropriate number of regions such as four regions. For each divided region, for example, if signals obtained from 90% or more of the pixels 204 arranged in the divided region satisfy the predetermined condition for generating the stop signal SS, the stop signal SS is supplied to the pixels 204 in this region. With this, power consumption can be suppressed for each divided region in the distance measurement sequence F. The percentage of the pixels 204 which output signals satisfying the predetermined condition for generating the stop signal SS is not limited to 90% or more of the pixels 204 arranged in each region. The percentage may be 50% or more, 60% or more, 70% or more, or 80% or more.

Alternatively, for example, if the plurality of signals obtained from each of a predetermined number of pixels 204 of the pixels 204 arranged in the predetermined region satisfy the predetermined condition for generating the stop signal SS, the stop control circuit 309 may supply the stop signal SS to all of the plurality of pixels arranged in the pixel portion 201. For example, the user sets a region of interest as the predetermined region. The region of interest may be one or some of regions obtained by dividing the pixel portion 201 into an appropriate number of regions. Alternatively, the user may set one or more arbitrary regions as the regions of interest. For example, if signals obtained from 90% or more of the pixels 204 arranged in the region of interest satisfy the predetermined condition for generating the stop signal SS, the stop signal SS is supplied to all the pixels 204. With this, distance information can be generated in the region of interest set by the user, and power consumption can be suppressed since detection operations more than necessary are not performed. The percentage of the pixels 204 which output signals satisfying the predetermined condition for generating the stop signal SS is not limited to 90% or more of the pixels 204 arranged in the region of interest. The percentage may be 50% or more, 60% or more, 70% or more, or 80% or more. The distance measurement device 100 may be configured such that, for example, the user can select the percentage of the pixels 204 which output signals satisfying the predetermined condition for generating the stop signal SS.

The operation for suppressing power consumption in the distance measurement device 100 has been described above. However, the arrangement of the distance measurement device 100 is not limited to that described above. In the above description, the APD 301 is used as the photoelectric conversion element, but, for example, a photodiode such as a PIN diode may be used as the photoelectric conversion element. In this case, the counter circuit 307 is not arranged, and the signal may be directly supplied from the PIN diode to the processing circuit 308. It has been described above that count values are used as the signal values of the plurality of signals. However, if the photodiode is used for the photoelectric conversion element, voltage values obtained at the timings of detection operations can be used as the signal values of the plurality of signals.

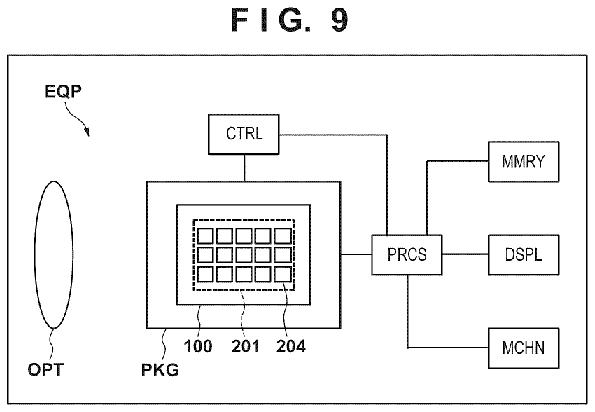

An application example of the distance measurement device 100 according to the embodiment described above will be described below. FIG. 9 is a schematic view of electronic equipment EQP incorporating the distance measurement device 100. The distance measurement device 100 can be a semiconductor chip with a stacked structure including the pixel portion 201 in which the pixels 204 are arranged. As shown in FIG. 9, the distance measurement device 100 is contained in a semiconductor package PKG. The package PKG can include a base to which the distance measurement device 100 is fixed, a lid such as glass facing the distance measurement device 100, and a conductive connecting member such as a bonding wire or bump used to connect a terminal provided on the base to a terminal provided on the distance measurement device 100. The equipment EQP may further include at least one of a control device CTRL, a processing device PRCS, a display device DSPL, and a storage device MMRY.

An optical system OPT forms an image on the pixel portion 201, and can be, for example, a lens, a shutter, and a mirror. The control device CTRL controls the operation of the distance measurement device 100, and can be, for example, a semiconductor device such as an ASIC or the like. The processing device PRCS processes a signal output from the distance measurement device 100, and can be, for example, a semiconductor device such as a CPU, an ASIC, or the like. The display device DSPL can be an EL display device or a liquid crystal display device that displays data obtained by the distance measurement device 100. The storage device MMRY is a magnetic device or a semiconductor device for storing data obtained by the distance measurement device 100. The storage device MMRY can be a volatile memory such as an SRAM, a DRAM, or the like or a nonvolatile memory such as a flash memory or a hard disk drive. A mechanical device MCHN can include a moving or propulsion unit such as a motor or an engine. The mechanical device MCHN drives the components of the optical system OPT for, for example, zooming, focusing, and shutter operations. In the equipment EQP, data output from the distance measurement device 100 is displayed on the display device DSPL, or transmitted to an external device by a communication device (not shown) included in the equipment EQP. Hence, the equipment EQP may also include the storage device MMRY and the processing device PRCS.

The equipment EQP incorporating the distance measurement device 100 is also applicable to a surveillance camera or an onboard camera mounted in transportation equipment such as an automobile, a railroad car, a ship, an airplane, or an industrial robot. In addition, the equipment EQP incorporating the distance measurement device 100 is not limited to transportation equipment but is also applicable to equipment that widely uses object recognition, such as an intelligent transportation system (ITS).

According to the present disclosure, a technique advantageous in suppressing power consumption can be provided.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-168872, filed Sep. 28, 2023, which is hereby incorporated by reference herein in its entirety.

What is claimed is:

1. A distance measurement device comprising: a plurality of pixels each including a photoelectric conversion element; and a calculation circuit configured to generate distance information based on signals obtained by the plurality of pixels, wherein
a sequence for generating the distance information includes a plurality of distance measurement frames,
each of the plurality of distance measurement frames includes a plurality of subframes which are different from each other in a time between light emission by a light source and a period in which a detection operation of detecting light reflected by a target object is performed by applying a reverse bias to the photoelectric conversion element,
the device further comprises a stop control circuit configured to generate a stop signal if a plurality of signals obtained by the detection operations respectively performed in the plurality of subframes satisfy a predetermined condition in the plurality of distance measurement frames, and
among the plurality of distance measurement frames, in a distance measurement frame after the stop signal is supplied from the stop control circuit, each of the plurality of pixels does not perform the detection operation.

2. The device according to claim 1, wherein
for each of the plurality of pixels, the stop control circuit generates the stop signal based on the plurality of signals obtained by each pixel.

3. The device according to claim 2, wherein
the stop control circuit is arranged in each of the plurality of pixels.

4. The device according to claim 1, wherein
the stop control circuit generates the stop signal based on the plurality of signals obtained by each pixel arranged in a predetermined region among the plurality of pixels.

5. The device according to claim 4, wherein
if the plurality of signals obtained from each of a predetermined number of pixels among pixels arranged in the predetermined region satisfy the predetermined condition, the stop control circuit supplies the stop signal to all pixels arranged in the predetermined region.

6. The device according to claim 4, wherein
if the plurality of signals obtained from each of a predetermined number of pixels among pixels arranged in the predetermined region satisfy the predetermined condition, the stop control circuit supplies the stop signal to all of the plurality of pixels.

7. The device according to claim 4, wherein
the stop control circuit is arranged outside a pixel portion where the plurality of pixels are arranged.

8. The device according to claim 1, wherein
the stop control circuit generates the stop signal for each of the plurality of pixels based on a plurality of signal values obtained by integrating, for the plurality of subframes, signal value of the plurality of signals obtained in each of the plurality of distance measurement frames.

9. The device according to claim 8, wherein
the predetermined condition includes a case where not less than one signal value of the plurality of signal values is not smaller than a predetermined threshold value.

10. The device according to claim 9, wherein
the stop control circuit detects the not less than one signal value based on a first derivative value of a histogram obtained from the plurality of signal values.

11. The device according to claim 9, wherein
the stop control circuit detects the not less than one signal value based on a second derivative value of a histogram obtained from the plurality of signal values.

12. The device according to claim 9, wherein
the not less than one signal value includes a peak value of the plurality of signal values.

13. The device according to claim 8, wherein
the predetermined condition includes a case where a degree of similarity between a predetermined waveform and a waveform of a histogram obtained from the plurality of signal values falls within a predetermined range.

14. The device according to claim 1, wherein
the photoelectric conversion element includes an avalanche photodiode.

15. Equipment comprising:
a distance measurement device defined in claim 1; and
a processing device configured to process a signal output from the distance measurement device.
